(19) United States
(12) Patent Application Publication
(10) Pub. No.: US 2022/0357272 A1
(43) Pub. Date: Nov. 10, 2022

(54) Sensor Including an Optical Microcavity on a Unitary Structure

(71) Applicant: Oxford HighQ Ltd, Oxford, Oxfordshire (GB)

(72) Inventors: Matteo Contino, Oxford, Oxfordshire (GB); Dean James, Oxford, Oxfordshire (GB); Robert Andrew Nyman, Oxford, Oxfordshire (GB); Jason Michael Smith, Oxford, Oxfordshire (GB); Aurélien André Paul Trichet, Oxford, Oxfordshire (GB); Claire Vallance, Oxford, Oxfordshire (GB)

(21) Appl. No.: 17/764,934

(22) PCT Filed: Sep. 15, 2020
(86) PCT No.: PCT/GB2020/052215

§ 371 Date: Mar. 29, 2022

(30) Foreign Application Priority Data
Sep. 30, 2019 (GB) 1914060.7

(51) Int. Cl. G01N 21/31; G02B 7/182

(52) U.S. Cl. CPC G01N 21/31; G02B 7/182; G01N 2201/0636

(57) ABSTRACT

A sensor is disclosed, comprising: a first optical reflector provided on a first support element; a second optical reflector provided on a second support element and arranged opposed to the first optical reflector along an optical axis, the opposed first and second optical reflectors being spaced from each other forming a sample space for containing a sample between the first and second optical reflectors; wherein the second optical reflector comprises a recess to provide an optical cavity with stable resonance in at least one mode and having an optical cavity length of at most 50 μm and/or an optical mode volume of 100 μm³ or less; at least one electromagnetic (EM) radiation source configured to illuminate the optical cavity with EM radiation; and a detector configured to detect EM radiation from the optical cavity; wherein the first support element and the second support element are bonded to each other and form a unitary structure.

### CROSS REFERENCE TO RELATED APPLICATIONS

This application represents the U.S. national stage entry of International Application No. PCT/GB2020/052215 filed Sep. 15, 2020, which claims priority to United Kingdom Patent Application No. 1914060.7 filed Sep. 30, 2019, the disclosures of which are incorporated herein by reference in their entirety and for all purposes.

### BACKGROUND

The present specification relates to a sensor. In particular, but not exclusively, the present specification relates to a sensor comprising first and second reflectors configured to provide an optical microcavity, in which the first and second reflectors are provided on a unitary structure.

Sensors based on optical microcavity structures have been demonstrated for various applications, including chemical sensing (for example, see US 2015/0077747 A1) and particle characterisation (for example, see WO 2017/203224 A1). The ability to measure chemical quantity and composition of liquids has a wide range of applications, for example in environmental science, defence technology and medical sciences. Open optical cavities allow a sample to be introduced into the cavity for sensing and are conventionally formed by two separate reflectors held close together by large-scale adjustable opto-mechanical components, such as kinematic mounts. Although this configuration enables the cavity length to be modified, fluctuations of the cavity length on timescales from as short as 1 ms are unavoidable and active locking of the cavity length is therefore required to decouple the optical microcavity from ambient noise.

### SUMMARY

Aspects of the present disclosure are set out in the accompanying independent and dependent claims. Combinations of features from the dependent claims may be combined with features of the independent claims as appropriate and not merely as set out in the claims.

According to an aspect of the present disclosure, there is provided a sensor comprising:

a first optical reflector provided on a first support element;

a second optical reflector provided on a second support element and arranged opposed to the first optical reflector along an optical axis, the opposed first and second optical reflectors being spaced from each other forming a sample space for containing a sample between the first and second optical reflectors;

wherein the second optical reflector comprises a recess to provide an optical cavity with stable resonance in at least one mode and having an optical cavity length of at most 50 μm and/or an optical mode volume of 100 μm³ or less;

at least one EM radiation source configured to illuminate the optical cavity with EM radiation; and

a detector configured to detect EM radiation from the optical cavity;

wherein the first support element and the second support element are bonded to each other and form a unitary structure.

By providing a sensor in which the respective first and second support elements for the first and second optical reflectors are bonded to each other to form a unitary structure, vibrations of the cavity length may be reduced due to the smaller size and increased stiffness of the first and second optical reflectors and/or their corresponding support elements. In addition, the resulting sensor may be more compact than conventional optical microcavity devices since the need for opto-mechanical alignment components may be reduced or eliminated. Since the first and second support elements are bonded to each other, the first and second optical reflectors may be pre-aligned relative to each other prior to bonding the first and second support elements to each other, such that subsequent re-alignment is unnecessary. As a result, the optical cavity may be more stable and robust than those based on conventional open microcavity opto-mechanics, and the sensor may be more amenable to mass-production techniques. Some relative movement along the optical axis may be possible, due to the sample space between the first and second optical reflectors, thereby allowing some degree of tuning of the optical cavity length. However, alignment of the first and second optical reflectors transverse to the optical axis may be substantially fixed once the first and second support elements are bonded to each other to form the unitary structure, so that realignment is not necessary during the lifetime of the sensor. This in turn results in a significant time saving during set-up and use of the sensor, since alignment of conventional optical micro-cavities requires both skill and time. Finally, despite its unitary structure, the microcavity is an ‘open’ microcavity in the sense that the intra-cavity medium can be changed to introduce different samples between the first and second reflectors.

The EM radiation source may be configured to illuminate the optical cavity with EM radiation to cause resonance within the optical cavity or to interact with a sample within the optical cavity. For example, in some applications, a sample located in the optical cavity and excited by EM radiation from the EM source may emit photons (e.g. by fluorescence) into a stably-resonant mode of the optical cavity.

The EM radiation from the optical cavity detected by the detector may be EM radiation that is transmitted through the optical cavity, reflected by the optical cavity or emitted by the sample itself (e.g. by fluorescence).

The recess may have a radius of curvature of 50 μm or less.

The optical cavity may have an optical mode volume of 10 μm³ or less.

The first and second support elements may each include a first portion and a second portion, wherein the first portions are bonded to each other and the second portions support the first and second optical reflectors.

In some embodiments, the first portions of the first and second support elements are located at a first end of the unitary structure and the second portions of the first and second support elements are located at a second end of the unitary structure and comprise cantilever structures.

Usefully, this arrangement provides good access to the sample space between the first and second reflectors and may also enable some relative movement between the first and second optical reflectors supported on the respective second portions of the first and second support elements, for example for tuning the length of the optical microcavity. In some embodiments, exploitation of a mechanical resonance of the unitary structure may allow modulation of the cavity length at a well-defined frequency, which may be useful for signal detection accompanied with noise rejection (phase-sensitive detection).

In some embodiments, the first portions of the first and second support elements are located at a first end of the unitary structure, wherein each of the first and second support elements comprises a further first portion located at a second end of the unitary structure, and wherein the second portions of the first and second support elements are located between the first and second ends of the unitary structure.

This configuration may be useful in further reducing vibrations of the optical cavity length. The first and second support elements may be sufficiently flexible to allow some relative movement between the first and second optical reflectors supported on the respective second portions of the first and second support elements, for example, for tuning the length of the optical microcavity.

The first support element and the second support element may be bonded directly to each other.

For example, the first support element and the second support element may be formed as a single block, for example as a monolithic structure.

The first support element and the second support element may be bonded to each other by a spacer located between the first support element and the second support element.

The spacer may be formed by a portion of the first or second support elements or by a separate component bonded between the first and second support elements.

The spacer may comprise an elastically-deformable material.

This feature may allow a greater degree of adjustment of the optical cavity length. The spacer may surround the sample space.

The spacer may comprise an actuator that is configured to adjust the relative positions of the first optical reflector and the second optical reflector along the optical axis to change the cavity length of the optical cavity.

This configuration may be useful in that the actuator may adjust the cavity length (e.g. to tune the resonant frequency of the optical microcavity) without flexing the first or second support member. In turn, this may be useful in adjusting the cavity length and typically also the optical mode volume without affecting the relative orientation of the first and second reflectors, or the alignment of the optical cavity transverse to the optical axis.

The spacer may be formed of a material which deforms when stimulated, thereby moving one or both of the optical reflectors relative to each other along the optical axis of the optical cavity.

For example, the spacer may comprise a piezoelectric material.

In contrast to conventional open microcavity devices in which opposing cavity reflectors are held in position relative to each other by adjustable optomechanical mounts to enable adjustment of the separation and relative orientation of the cavity reflectors, the sensor of the present disclosure allows only very restricted adjustments of the relative positions of the first and second optical reflectors. Such adjustments require deformation of the unitary structure, for example by elastic deformation, piezoelectric deformation or flexing of the first and/or second support elements and/or the spacer (if present).

The sensor may further comprise an actuator configured to adjust the relative positions of the first optical reflector and the second optical reflector along the optical axis to change the cavity length of the optical cavity.

This configuration may enable the unitary structure to be aligned and bonded independently of any actuator, while providing adjustment of the optical cavity length (and potentially the optical cavity mode volume) by means of an actuator external to the unitary structure. The actuator may comprise a piezoelectric material.

The unitary structure may be rigid such that the first optical reflector and the second optical reflector have a fixed separation.

That is, the spacing between the first and second optical reflector may be substantially non-adjustable, such that the alignment and cavity length of the optical microcavity between the first and second optical reflectors is stable. By the term “fixed”, it is to be understood that small changes to the separation between the first and second optical reflectors may nonetheless occur due to ambient temperature changes or the like. Such small changes are expected to be less than one wavelength of light, e.g. of the order of 10 nm or less.

The sensor may comprise a plurality of said recesses providing a corresponding plurality of said optical cavities.

That is, each recess may provide an optical cavity with stable resonance in at least one mode and having an optical cavity length of at most 50 μm and/or an optical mode volume of 100 μm³ or less. The plurality of said recesses may be arranged as an array or lattice. At least one of said plurality of said recesses may be a reference cavity.

The recess or recesses may be spherical, or may have some other profile, for example a ‘double-dip’ type profile in which a single cavity mode is spread over more than one dimple within a recess. The recesses may support distinct respective optical microcavity modes. However, in an array or lattice of recesses having a reduced separation between neighbouring recesses, optical microcavity modes may extend over more than one recess.

The plurality of optical cavities may have different optical cavity lengths and/or optical mode volumes and/or optical mode shape thereby providing more than one cavity length and/or optical mode volume and/or mode shape.

This feature may, for example, provide optical cavities tuned to different resonant frequencies for interacting with different samples or for interacting differently with a single sample. Optical modes having the same mode volumes but different shapes (for example, having a different number of nodes transverse to optical axis) may interact differently with samples of interest.

Embodiments in which the sensor comprise a plurality of said recesses providing a corresponding plurality of said optical cavities having different optical cavity lengths may enable common mode noise to be reduced or eliminated from measurements. This is particularly beneficial when the plurality of optical cavities are illuminated by a broadband EM radiation source, since changes in intracavity refractive index or cavity length may result in changes in transmitted power of an optical microcavity and would therefore be indistinguishable from the effect of intracavity absorption when only a single optical microcavity is monitored.

The at least one EM radiation source may be configured to illuminate the plurality of optical cavities.

That is, multiple optical cavities may be illuminated using the same EM radiation source or sources. In some embodiments, multiple optical cavities may be illuminated using a single EM radiation source. This may usefully reduce the overall size, complexity and cost of the sensor.

The at least one EM radiation source may be configured to illuminate the optical cavity or the plurality of optical cavities with EM radiation comprising a plurality of frequencies.

Accordingly, this enables resonant modes in different optical cavities having different resonant frequencies to be driven. Similarly, multiple resonances within a single optical cavity may be driven. The plurality of frequencies of EM radiation may comprise a continuous range of frequencies and/or a plurality of discrete frequencies or ranges of frequencies and/or a plurality of spatial modes. The plurality of frequencies may be coherent, incoherent (for example to avoid speckle) or partially coherent. The at least one EM radiation source may comprise at least one EM radiation source providing EM radiation over a continuous range of frequencies or at multiple discrete frequencies. Alternatively, the at least one EM radiation source may comprise multiple EM radiation sources providing EM radiation at different frequencies or over different (but optionally overlapping) ranges of frequencies. The at least one EM radiation source may comprise a laser source and/or a broadband source. For example, the EM radiation source may comprise an LED, in particular, the EM radiation source may comprise a large-area light source.

The detector may be arranged to detect EM radiation from the plurality of optical cavities and to discriminate between EM radiation from the different optical cavities.

The EM radiation from different optical cavities may be discriminated spatially, for example through detection by different portions of the detector. For example, the detector may be an array detector, for example a camera or image sensor, or an array of photodiodes. EM radiation from different respective optical cavities may be detected by different pixels of an image sensor or different photodiodes of a photodiode array. Alternatively, EM radiation from the different optical cavities may be discriminated spectrally, for example using an optical spectrometer, of temporally, for example if using multiple, modulated EM radiation sources.

Said EM radiation source and/or said detector may be arranged directly adjacent to said respective first or second optical reflector or said first or second support element.

This may be facilitated by the unitary structure of the first and second support elements, in that bulky adjustable optomechanical mounts are not required for supporting and aligning the first and second support elements relative to each other. The close proximity of said EM radiation source and/or said detector to the respective first or second optical reflector may further reduce the overall size of the sensor and reduce power requirements and costs. By arranging said EM radiation source and/or said detector directly adjacent to said respective first or second optical reflector or said respective first or second support element, such that the sensor comprises no optics for collimating or focussing the EM radiation between the EM radiation source and the first optical reflector, or between the second optical reflector and the detector, further reductions in size and cost may be achieved. The EM radiation source and/or the detector may be in contact with or formed on the first and/or second optical reflector.

The sensor may further comprise at least one inlet for introducing a fluid sample into the sample space and at least one outlet for removing the fluid sample from the sample space.

In some embodiments, two or more inlets and/or outlets may be provided. Fluid may be conveyed through the inlet, sample space and/or outlet by capillary action, capillary electrophoresis or by forced liquid transport (e.g. via externally imposed pressure).

The sensor may further comprise a gasket structure between the first and second support elements, to contain a fluid sample within the sample space.

The gasket structure may be elastically-deformable to allow small adjustments of the optical cavity length. For example, the gasket structure may comprise an elastically-deformable sheet (e.g. a rubber sheet) with a central opening in the region of the sample space. In embodiments in which the first and second support elements are bonded to each other via a spacer, the gasket structure and spacer may be provided by the same element.

### BRIEF DESCRIPTION OF THE DRAWINGS

FIG. 1 schematically illustrates a sensor according to an embodiment of this disclosure;

FIG. 2 illustrates isometric (top), plan (middle) and side (bottom) views of a unitary structure provided with fluid control components for a sensor according to an embodiment of this disclosure;

FIG. 3 illustrates isometric (top) and side (bottom) views of a unitary structure for a sensor according to an embodiment of this disclosure;

FIG. 4 illustrates isometric (top) and side (bottom) views of a unitary structure for a sensor according to another embodiment of this disclosure; and

FIG. 5 illustrates isometric (top) and side (bottom) views of a unitary structure for a sensor according to another embodiment of this disclosure.

### DETAILED DESCRIPTION

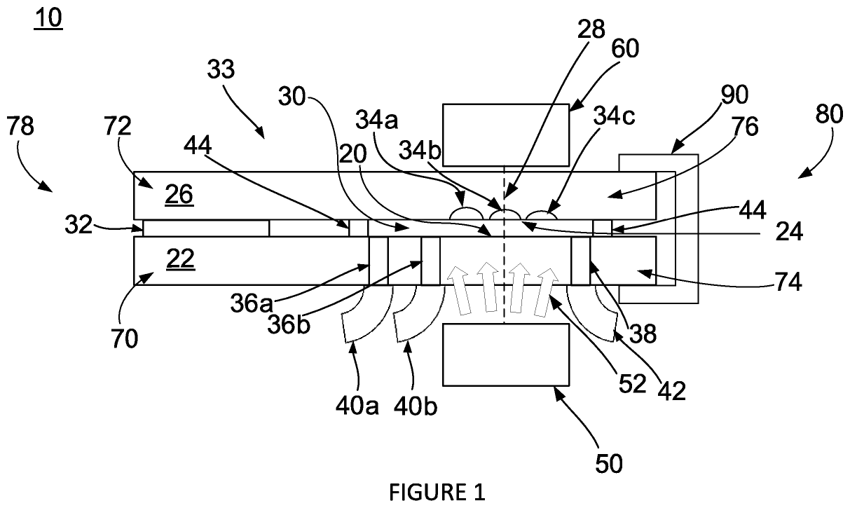

FIG. 1 illustrates a sensor 10 according to an embodiment of this disclosure. The sensor 10 comprises a first optical reflector 20 provided on a first support element 22 and a second optical reflector 24 provided on a second support element 26. The second optical reflector 24 is arranged opposed to the first optical reflector 20 along an optical axis 28 and is spaced apart from the first optical reflector 20 to form a sample space 30 for containing a fluid sample between the first and second optical reflectors 20, 24. The first support element 22 and the second support element 26 are bonded to each other by a spacer 32 located between the first and second support elements 22, 26 to form a unitary structure 33. In this embodiment, the spacer 32 is bonded to each of the first and second support elements 22, 26, but in other embodiments a spacer may be formed by a portion of the first and/or second support elements. As an example only, the first and second support elements 22, 26 may have a length and width each in the range 3 mm to 50 mm and a thickness in the range 100 microns to 2 mm. The spacer 32 may have a transverse size in the range 1 mm to 50 mm and a thickness in the range 0.5 mm to 3 mm. The spacer 32 may be recessed into the first and/or second support elements 22, 26, the recess depth being close to the thickness of the spacer 32, to ensure a very small separation between the first and second optical reflectors 20, 24 of up to about 50 microns.

The first optical reflector 20 is planar, while the second optical reflector 24 comprises three recesses 34a, 34b, 34c to provide three respective optical cavities. In this embodiment, each optical cavity is configured to support stable resonance in at least one mode, the optical cavities having an optical cavity length of at most 50 μm and/or an optical mode volume of 100 μm³ or less. In some embodiments, the recesses 34a, 34b, 34c may each have an optical mode volume of 10 μm³ or less. In some embodiments, the recesses 34a, 34b, 34c may have a radius of curvature in the range 4 microns to 200 microns, and may have a depth in the range 50 nm to 2 microns. In some embodiments, the recesses may each have a radius of curvature of at most 50 μm. The optical cavity length is determined by the separation between the first and second optical reflectors 20, 24, and the depths of the respective recess 34a, 34b, 34c, and may be in the range 0.25 microns to 25 microns, i.e. between around 1 and 100 half-wavelengths of light. The cavity lengths of the optical microcavities formed by the respective recesses 34a, 34b, 34c may be substantially identical or different from each other. Different cavity lengths may be obtained by forming recesses of different depths 34a, 34b, 34c. Alternatively, different cavity lengths may be obtained by aligning the first and second optical reflectors 20, 24 at a non-zero relative angle (i.e. non-parallel).

A fluid sample may be introduced into the sample space 30 via inlets 36a, 36b and removed from the sample space 30 via an outlet 38. The inlets 36a, 36b and outlet 38 are provided by fluidic channels extending through the second support element 26 and respectively connected to a fluid supply or drain (not shown) by respective connectors 40a, 40b, 42. The number of inlets 36a, 36b and outlets 38 may differ from those shown in FIG. 1. Fluid may be driven through the inlets 36a, 36b, sample space 30 and outlet 38 by various means, for example capillary action, capillary electrophoresis or forced liquid transport (e.g. by pumping). A compressible gasket 44 is provided between the first and second support elements 22, 26, and surrounding the sample space 30 to retain a fluid sample within the sample space 30. This configuration may allow the fluid ‘dead’ volume within the gasket 44 to be significantly smaller than the corresponding volume in sensors based on conventional open microcavity opto-mechanics. The provision of multiple inlets 36a, 36b may be useful in controlling the flow of a fluid through the sample space 30, for example by controlling laminar flow lines of the fluid flowing through the sample space 30. Alternatively, each inlet 36a, 36b could be used to supply different fluid samples (for example a reference sample and a sample of interest) to the sample space 30, for example so that each optical microcavity receives fluid from one or other of the inlets, or to provide a switch-like action in which the flow of fluid from one inlet 36a is used to effectively push the flow of fluid from the other inlet 36b towards or away from an optical microcavity.

Although the present embodiment is adapted for analysis of fluid samples, other embodiments of the sensor may be adapted for analysis of solid samples, in which case the inlets 36a, 36b, outlet 38 and gasket 44 could be omitted. A solid sample could be introduced into the sample space 30 during manufacture of the sensor, for example as a layer bonded or deposited on one or both of the first and second optical reflectors. This may be suited for applications involving monitoring intracavity fluorescence.

The sensor further comprises an electromagnetic (EM) radiation source 50 and detector 60. The EM radiation source 50 is provided in the form of a multimode light source 50, configured to illuminate the three optical cavities with EM radiation 52 comprising a plurality of frequencies. The detector 60 is provided in the form of an array detector 60 (for example a rectangular or linear array) configured to detect EM radiation from the three optical cavities.

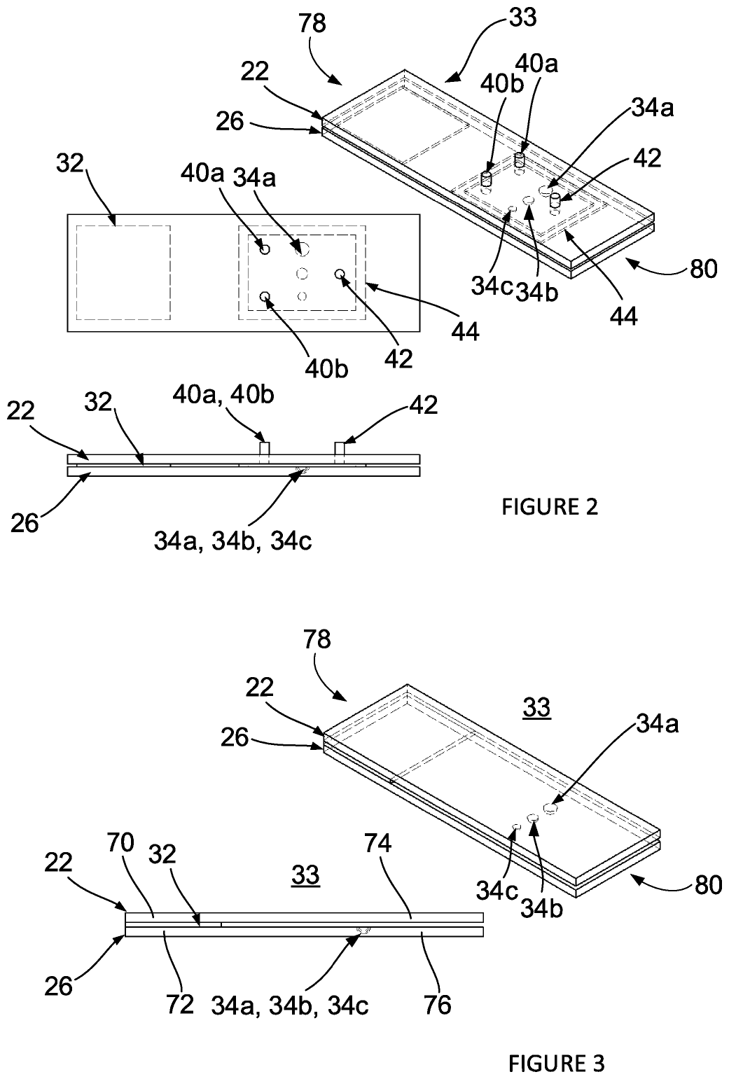

FIG. 2 illustrates a part of the sensor 10 of FIG. 1, comprising the unitary structure 33, fluid connectors 40a, 40b, 42, and gasket 44, in more detail. It can be seen in FIG. 2 that the compressible gasket 44 extends around the sample space 30 to retain a fluid sample within the sample space 30. The fluid inlets 40a, 40b and outlet 42 are in fluid communication with the sample space 30.

FIG. 3 illustrates the unitary structure 33 of FIGS. 1 and 2. It can be seen from the side view shown in FIG. 3 that the spacer 32 bonds respective first portions 70, 72 of the first and second support elements 22, 26 to each other, while the first and second optical reflectors 20, 24 are provided on respective second portions 74, 76 of the first and second support elements 22, 26. The spacer 32 extends substantially across the whole width of the first and second support elements 22, 26. With reference to FIGS. 2 and 3, it can be seen that the spacer 32 is positioned substantially at a first end 78 of the unitary structure 33, i.e. the respective first portions 70, 72 are located at a first end 78 of the first and second support elements 22, 26. The second portions 74, 76 of the first and second support elements 22, 26 are located at a second end 80 of the unitary structure 33 and form cantilever structures.

The cantilever configuration of the unitary structure 33 illustrated in FIGS. 1 to 3 allows some relative movement of the first and second optical reflectors 20, 24, towards and away from each other. This movement is primarily parallel to the optical axis 28 and can therefore be controlled to make small changes to the cavity length of the optical microcavity, without substantially changing the alignment of the first and second optical reflectors 20, 24 in the transverse directions. Changes to the optical cavity length of up to around 1 micron, allowing changes of up to around the wavelength light, are possible, thereby enabling the optical cavity to be scanned across cavity modes.

In some embodiments, the spacer 32 may be compressible, for example it may comprise an elastically deformable material to enhance adjustability of the optical cavity length. In some embodiments (not shown), the compressible gasket 44 may provide the function of a spacer such that a separate spacer is not required.

The sensor 10 illustrated in FIG. 1 also comprises an actuator 90 configured to adjust the relative positions of the first and second optical reflectors 20, 24 along the optical axis 28 to change the cavity length and/or the optical mode volume of the optical microcavity. In this embodiment, the actuator 90 is in the form of a clamp structure which clamps around the outer surfaces of the free ends 74, 76 of the first and second support elements 22, 26 and comprises means for adjusting the separation between the free ends 74, 76 of the first and second support elements 22, 26. For example, the actuator 90 may comprise a material which deforms when stimulated, for example a piezoelectric material. Because the actuator 90 is provided externally to the unitary structure 33, the cavity length may be adjusted without significantly changing the transverse alignment of the first and second optical reflectors 20, 24. The skilled person will appreciate that other embodiments may comprise an external actuator of a different type or having a different form.

In other embodiments, the cavity length may be adjusted by other means. For example, the spacer 32 may comprise an actuator that is configured to adjust the relative positions of the first and second optical reflectors 20, 24 along the optical axis 28 to change the cavity length and/or the optical mode volume of the optical microcavity. For example, the spacer 32 may comprise or be formed of a material which deforms when stimulated such as a piezoelectric material. This arrangement may be useful in obtaining relative movement of the first and second reflectors 20, 24 substantially along a single axis and/or without flexing the first or second optical reflector 20, 24.

The sensor 10 of the example embodiment illustrated in FIG. 1 may be configured as follows. The three recesses 34a, 34b, 34c provided on the second optical reflector 24 may each have a radius of curvature of 25 microns and depth of 500 nm, and be arranged in line, spaced apart from each other by 50 microns in the plane of the second optical reflector 24. The first and second optical reflectors 20, 24, may be separated by around 5 microns (that is, by around 20 half-wavelengths of light) and misaligned from each other by around 100 micro-radians so that the cavity lengths of the neighbouring optical microcavities differ by about 5 nm. The three recesses 34a, 34b, 34c may be fabricated into a fused silica substrate having a thickness of 200 microns and an area of 5 mm square, then coated with dielectric mirrors to provide the required reflectivity. The first and second support elements 22, 26 may be provided by the fused silica substrates (onto which the recesses 34a, 34b, 34c are fabricated) and aluminium pieces, the aluminium pieces having a thickness of 1 mm and an area of 10 mm square, and including openings into which the fused silica substrates are bonded. The spacer 32 may be a solid spacer, glued between the first and second support elements 22, 26 at one end. As an actuator, a piezo element may be glued between the first and second support elements 22, 26 at the other end, opposite to the spacer 32. This configuration may allow an adjustable scanning range of the cavity lengths of the optical microcavities, formed between the planar first optical reflector 20 and the respective recesses 34a, 34b, 34c of the second optical reflector 24, of around 100 nm. The EM radiation source 50 may be an LED (a very wide range of LED frequencies may be used, from the near UV to far IR) and having an area 1 mm across, and may be glued to the back of one of the optical reflectors 20, 24. The detector 60 may be a CCD or CMOS image sensor having a sensor area at least 3 mm across, and glued directly to one of the support elements 22, 26 such that it is located at about 300 microns from the reflective surface of the respective optical reflector 20, 24.

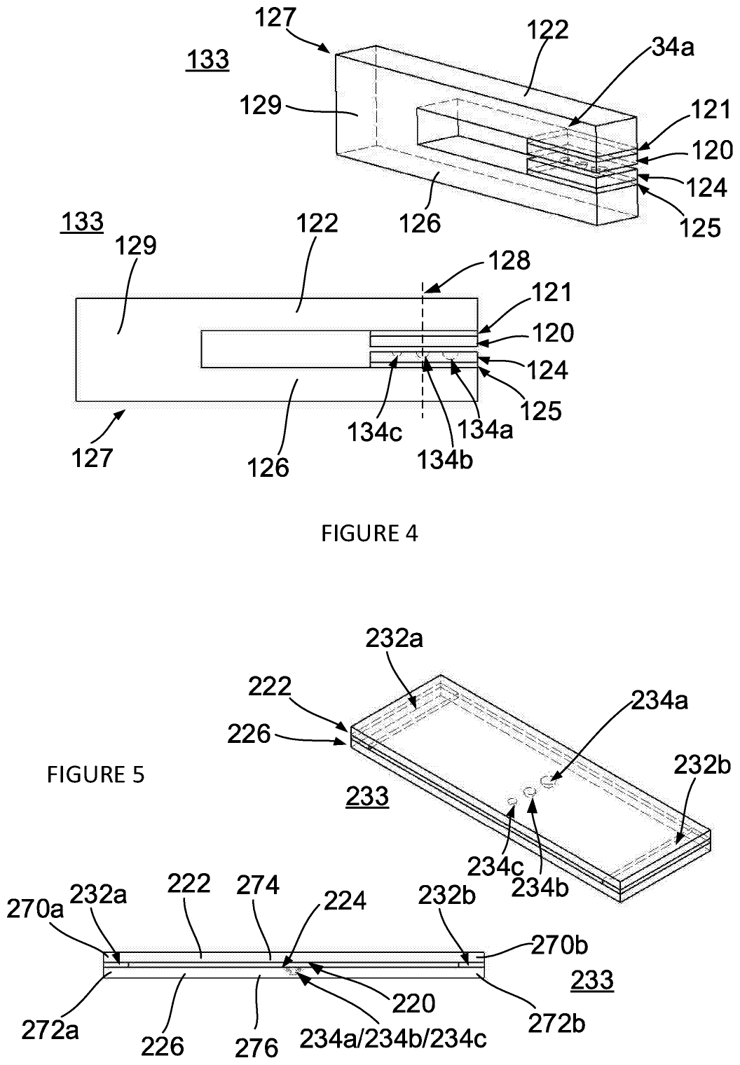

FIG. 4 illustrates an alternative embodiment of a unitary structure 133 which may be incorporated into a sensor in accordance with the present disclosure. The unitary structure 133 comprises a first optical reflector 120, a first support element 122, a second optical reflector 124, and a second support element 126. In this embodiment, the first and second support elements 122, 126 are provided by a support element 127 formed as a single block. That is, the first and second support elements 122, 126 are bonded to each other as a result of being manufactured as a single block. The support element 127 is effectively U-shaped, comprising the first and second support elements 122, 126 in the form of respective arms extending parallel to each other from an end portion 129 of the support element 127. In this embodiment, the first and second optical reflectors 120, 124 are respectively provided on first and second substrates 121, 125, which in turn are respectively bonded to the free ends of the first and second support elements 122, 126 so as to oppose each other along an optical axis 128. The free ends of the first and second support elements 122, 126, on which the first and second optical reflectors 120, 126 are provided, form cantilever structures. As discussed in connection with FIGS. 1 to 3 above, the cantilever configuration of the unitary structure 133 illustrated in FIG. 4 allows some relative movement of the first and second optical reflectors 120, 124, towards and away from each other. This movement is primarily parallel to the optical axis 128 and can therefore be controlled to make small changes to the cavity lengths of the optical cavities (formed between the first optical reflector 120 and the respective recesses 134a, 134b, 134c of the second optical reflector 124), without substantially changing the alignment of the first and second optical reflectors 120, 124 in the transverse directions.

In the embodiment shown in FIG. 4, the support element 127 comprising the end portion 129 and the first and second support elements 122, 126, may be formed from a piezoelectric material, for example quartz, to enable the optical cavity lengths to be adjusted by controlling electric voltages applied to the support element 127.

The embodiment shown in FIG. 4 may be particularly suited to exploitation of a mechanical resonance of the support element 127 of the unitary structure 133, for example for phase-sensitive detection with noise rejection. As an example, the first and second support elements 122, 126 may have a length and width in the range 3 mm to 50 mm and a thickness in the range 100 microns to 2 mm. By ensuring that the end portion 129 is a node of the mechanical motion, the whole unitary structure can be mounted by the end portion 129 without introducing mechanical damping. In embodiments in which the unitary structure 133 is piezo-mechanically resonant, low applied voltages may be used to achieve relatively large amplitudes of motion, reducing electrical power consumption.

FIG. 5 illustrates an alternative embodiment of a unitary structure 233 which may be incorporated into a sensor in accordance with the present disclosure. The unitary structure 233 comprises a first optical reflector 220, a first support element 222, a second optical reflector 224, a second support element 226, and first and second spacers 232a, 232b. The first and second support elements 222, 226 each include a first portion 270a, 272a located substantially at a first end of the respective support element 222, 226, and a further first portion 270b, 272b located substantially at a second end of the respective support element 222, 226, opposite to the first end. Each of the first and second support elements 222, 226 comprises a second portion 274, 276, located between the first portion 270a, 272a and further first portion 270b, 272b of the respective support element 222, 226. The first portions 270a, 272a are bonded to each other by the first spacer 232a, while the further first portions 270b, 272b are bonded to each other by the second spacer 232b. The first and second optical reflectors 220, 224 are provided on the respective second portions 274, 276 of the first and second support elements 222, 226. Each of the spacers 232a, 232b extends substantially across the whole width of the first and second support elements 222, 226. Thus the first and second support elements 222, 226 are bonded to each other at each end. This configuration of the unitary structure 233, illustrated in FIG. 5, may allow some relative movement of the first and second optical reflectors 220, 224, towards and away from each other due to the sample space between the first and second optical reflectors 220, 224. This movement is primarily parallel to the optical axis and can therefore be controlled to make small changes to the cavity length of the optical cavity, without substantially changing the alignment of the first and second optical reflectors 220, 224 in the transverse directions. By locating the first and second optical reflectors 220, 224 substantially centrally between the spacers 232a, 232b, changes to the transverse alignment of the first and second optical reflectors 220, 224 occurring when the optical cavity length is changed may be minimised or eliminated. By bonding the support elements 222, 226 to each other at two locations, on opposite sides of the optical reflectors 220, 224, vibrations of the optical cavity length may be further reduced.

Although each of the embodiments described above with reference to FIGS. 1 to 5 may allow some relative movement between the first and second optical reflectors 20, 24, 120, 124, 220, 224 towards and away from each other, the unitary structures 33, 133, 233 may alternatively be formed as rigid structures so that the first and second optical reflectors have a substantially fixed separation.

The unitary structure 33 may be formed as follows. The first optical reflector 20 and associated first support element 26 may be made by coating a planar silica substrate with a high-reflectivity mirror, for example a high-reflectivity Bragg mirror. The second optical reflector 24 and associated second support element 26 may be made using various techniques known in the art, for example by using focused ion beam milling, to produce concave surfaces in a silica substrate, and coating the resulting substrate with high-reflectivity mirrors. The mirrors may comprise high-reflectivity Bragg mirrors, for example dielectric Bragg reflector stacks comprising alternating layers of SiO₂/TiO₂ with high refractive index for the last layer to minimise field penetration into the mirrors. The spacer 32 may be formed from a planar silica substrate. The first and second support elements 22, 26 (supporting the first and second optical reflectors 20, 24) may then be mounted in an alignment jig allowing fine control over the relative separation and angle between the reflectors 20, 24. Once aligned, the first and second support elements 22, 26 may be bonded to opposing surfaces of the spacer 32 to form the unitary structure 33. Various bonding techniques may be used, including adhesives (e.g. UV-curing glues or two-part epoxies), friction welding, and others. The first and second support elements 22, 26 may remain in the alignment jig until bonding is complete, so that the alignment of the first and second optical reflectors 20, 24 may be monitored and adjusted, if necessary, throughout the bonding process.

Because the first and second optical reflectors 20, 24 are bonded to each other to form a unitary structure 33, optomechanical components for mounting the first and second optical reflectors 20, 24 may be reduced in size or eliminated altogether, in particular since the bonded structure means that it is not necessary to regularly realign the optical cavities. As a result, the EM radiation source 50 and detector 60 may be positioned much closer to the optical cavity in the present disclosure than in conventional sensors based on optical microcavities, further reducing the overall size of the sensor 10. In particular, the EM radiation source 50 may be fixed in position close to the outside of the optical cavity or cavities and may therefore require little or no collimation optics, beam-shaping or alignment optics. This in turn reduces the power requirements of the EM radiation source 50 and/or may enable a broadband light source to be used for the EM radiation source. For example, an extended light source such as a large area LED, having an area similar to the area comprising the array of recesses 34a, 34b, 34c forming the optical microcavities, could be held in position relative to the optical microcavities by a jig. Once aligned, the light source 50 could be fixed in place, for example by bonding it to a fixed spacer. The distance between the light source 50 and the optical microcavities may typically be of the order of a few millimetres, up to around 10 millimetres.

Although the embodiments shown in FIGS. 1 to 5 each comprises three optical microcavities, each formed between the planar first optical reflector 20, 120, 220 and a respective recess 34a, 34b, 34c; 134a, 134b, 134c; 234a, 234b, 234c of the second optical reflector 24, 124, 224, other embodiments may comprise different configurations of optical cavities. For example, the second optical reflector may comprise one or more recesses for providing one or more respective optical cavities. In embodiments comprising multiple optical cavities, one or more of the optical microcavities may be formed by a recess providing an optical cavity with stable resonance in at least one mode and having an optical cavity length of at most 50 μm and/or an optical mode volume of 100 μm³ or less.

In embodiments comprising multiple optical cavities, the optical microcavities may have different optical cavity lengths, different optical mode volumes and/or different mode shapes, obtained by varying the dimensions (e.g. depth and/or radii of curvature) or shapes of the respective recesses 34a, 34b, 34c, or by misaligning the first and second optical reflectors from parallel. By varying the optical cavity length, different optical microcavities 34a, 34b, 34c of a single sensor 10 may be tuned to different resonant frequencies of EM radiation. Different samples introduced into the sample space 30 may then interact with different optical microcavities. For example, each optical microcavity could be configured for detection of a different sample. By varying the optical mode volume or mode shape, a single sample may interact differently with each optical microcavity. In some embodiments, multiple optical microcavities may be arranged as a lattice or an array. Alternatively, or in addition, embodiments of the sensor comprising multiple optical cavities may comprise one or more ‘sample’ and ‘reference’ cavities, whereby a measurement (intensity or wavelength) of the radiation output from the or each ‘sample’ cavity is normalised using a corresponding measurement of radiation output from one or more ‘reference’ cavities. This can be used to remove background noise.

In addition, the optical microcavities may have different optical transmission and reflection spectra, e.g. different reflectivity bands. This may be useful, for example, to measure different colorimetric reactions on a single chip by simply illuminating it with two different wavelengths (simultaneously or sequentially). For example, a multiple reflection distributed Bragg reflector (DBR) can be used which effectively leads to two stop bands for each optical microcavity. Alternatively, during DBR coating one could stop the rotation of the planetary sample holder in order to obtain a gradient of layer thickness across the area of the three microcavities resulting in different reflection spectra for each microcavity. Alternatively, a number of samples with different DBR coated on them could be combined.

In embodiments in which multiple optical microcavities 34a, 34b, 34c of a single sensor 10 are tuned to different resonant frequencies of EM radiation, a broadband EM source 50 (i.e. an EM source 50 outputting EM radiation comprising a plurality of frequencies) may be used to excite resonance of all the optical microcavities simultaneously. For example, a large area LED may be used. Depending on the specific application, other suitable light sources may include broad area lasers, tapered amplifier-master oscillators, supercontinuum light sources, and semiconductor lasers operated below threshold power. Alternatively, multiple EM radiation sources may be used, each providing a different frequency or range of frequencies of EM radiation. A ‘medium’ broadband source having a frequency range broader than the resonance linewidth of the optical microcavity but narrower than the mode spacing of the optical microcavity may be suitable for some applications, for example for measuring transmission through multiple optical microcavities without scanning. Although some ‘medium’ broadband sources exist, a broadband source having a broader spectrum could effectively be converted to a ‘medium’ broadband source by adding a notch filter. A similar effect could be achieved by applying the notch filter to the detector (detector-side ‘medium’ broadband filtering). On the other hand, some applications may require a broadband source having a frequency range broader than the optical mode spacing, for example for addressing samples with widely spaced optical responses, such as multiple chromophores in a solution.

For some applications a narrowband EM radiation source (i.e. a laser), typically outputting EM radiation having a frequency range narrower than the resonance linewidth of the optical microcavity, may be preferred, for example for transmission measurements on a single cavity while scanning the optical cavity length or EM radiation frequency.

While coherent light may be preferred when measuring the transmission of a single cavity while scanning, incoherent light may be preferred when addressing a large number of cavities with a single EM source. Partial coherence may be preferred for some intermediate cases such as a few cavities with or without length modulation.

The detector 60 may be an array detector such as a CCD or CMOS image sensor or a photodiode array, which may discriminate between detected EM radiation from different optical microcavities. In some embodiments, the detector 60 may be provided with focussing optics, for example in the form of a lenslet array.

As discussed above in connection with the EM radiation source 50, the configuration of the unitary structure 33, 133, 233 may allow the detector 60 to be positioned much closer to the optical cavity in the present disclosure than in conventional sensors based on optical microcavities, further reducing the overall size of the sensor 10. In particular, the detector 60 may be fixed in position close to the outside of the optical cavity, for example at a distance of as little as 500 microns, and may therefore require little or no focussing optics or alignment optics. In particular, the requirement for a conventional objective lens may be eliminated. As another example, by bonding a detector in the form of a CCD array directly to the first or second optical reflector of the optical microcavity, it is feasible to capture 100% of the transmitted light on the detector (e.g. for a detector positioned at a distance of several hundred microns, and assuming a beam divergence of only 10 to 20 degrees). The distance between the detector 60 and the optical microcavities may be reduced even further, effectively to zero separation, by forming one of the first and second optical reflectors directly on the detector 60, for example by coating a pixel of an avalanche photodiode (APD) array or a linear array CCD with a distributed Bragg reflector (DBR) to form a cavity reflector.

By being able to position the EM radiation source 50 and detector 60 so close to the first and second optical reflectors 20, 24, the overall size of the sensor 10 and power requirements may each be reduced significantly compared to conventional sensors based on optical microcavities. The sensor 10 may thus be configured as a portable device, for example a hand-held device. Excluding the electronics, fluid pumps and chemical reservoirs, the sensor 10 may fit within a volume of 10 cm×10 cm×10 cm.

The sensor of the present disclosure is suitable for use as a chemical sensor. A chemical sample may be introduced into the sample space 30 via inlets 36a, 36b, the optical microcavity illuminated with EM radiation 52 from the EM radiation source 50, and EM radiation from the optical microcavity detected using the detector 60. The detected EM radiation may be emitted from, transmitted through, or reflected from the optical microcavity. In one example, cavity-enhanced absorption spectroscopy may be used to detect the presence of a chemical species by tuning a wavelength of the EM radiation 52 to a wavelength of a characteristic absorption band for the chemical species of interest, and observing a reduction in the detected EM radiation output from the optical microcavity when the chemical species is present within the optical microcavity. In another example, chemical sensing may be implemented by employing the sensitivity of the optical microcavity to the refractive index of the medium in the sample space 30. In this case, the presence of a chemical species is detected by observing a change in the refractive index of the sample in the optical microcavity characteristic of a particular sample. This may manifest, in the case of illumination with EM radiation 52 from a broadband source, as a shift in the wavelength transmitted through the optical microcavity and/or, if the spectrum of the EM radiation source is not uniform, a change in the intensity of EM radiation transmitted through the optical microcavity. In the case of illumination with EM radiation 52 having a narrowband wavelength tuned to the resonant wavelength of the optical microcavity, a change of refractive index in the intracavity medium may be observed as a change in the intensity of EM radiation transmitted through the cavity as the changing refractive index brings the optical microcavity in or out of resonance with the wavelength of the EM radiation 52. Further examples of methods for chemical sensing include cavity-enhanced fluorescence sensing and Raman spectroscopy.

A sensor providing multiple optical microcavities having different optical cavity lengths may be used to reduce or eliminate common-mode noise from measurements of the intensity or wavelength transmitted by the multiple optical microcavities. One source of common mode noise in the sensor described above is fluctuations in the separation between the first and second optical reflectors, which in turn cause fluctuations in the optical cavity lengths and thus a global shift in the transmission spectrum of the optical microcavities. Thus, by using two or more optical microcavities having different cavity lengths, a common-mode shift of the cavity resonances can be subtracted from a shift in the transmission spectrum of one optical microcavity caused by a refractive index change due to the presence of a sample. Similarly, a change in refractive index at all microcavities results in a shift in transmission spectrum which is greater for longer cavity lengths and can therefore also be deconvolved from common-mode noise.

When using a broadband EM radiation source, a shift in transmission wavelength may appear as a change in transmitted intensity if the spectrum of the EM radiation source is not flat. Therefore, measured changes in transmission intensity of an optical microcavity can originate from absorption by a sample in the microcavity, or by a change in refractive index or optical microcavity length. By providing multiple optical microcavities having different optical cavity lengths, these effects can be deconvolved as they each produce different effects. In this way, an important source of common-mode noise (e.g. cavity length fluctuations or refractive index changes) can be eliminated from absorption measurements. It is a particular advantage in the present invention to be able to reduce or eliminate common-mode noise arising from cavity length fluctuations using post-processing of the measured signals. By avoiding using feedback to actively control the cavity length, the sensor may be more compact and less complex.

Further rejection of noise may be achieved by providing more than three optical microcavities. By scanning three optical microcavities to determine the three optical cavity lengths, both the separation and relative orientation of the first and second optical reflectors may be determined. With more than three optical microcavities, common-mode relative motion of the first and second optical reflectors can be rejected, enabling extraction of information about the intracavity medium.

Although particular embodiments of this disclosure have been described, it will be appreciated that many modifications, additions and/or substitutions may be made within the scope of the claims.

1. A sensor comprising:
a first optical reflector provided on a first support element;
a second optical reflector provided on a second support element and arranged opposed to the first optical reflector along an optical axis, the opposed first and second optical reflectors being spaced from each other forming a sample space for containing a sample between the first and second optical reflectors;
wherein the second optical reflector comprises a recess to provide an optical cavity with stable resonance in at least one mode and having an optical cavity length of at most 50 μm and/or an optical mode volume of 100 μm³ or less;
at least one EM radiation source configured to illuminate the optical cavity with EM radiation; and
a detector configured to detect EM radiation from the optical cavity;
wherein the first support element and the second support element are bonded to each other and form a unitary structure.

2. A sensor according to claim 1,
wherein the first and second support elements each include a first portion and a second portion, wherein the first portions are bonded to each other and the second portions support the first and second optical reflectors.

3. A sensor according to claim 2,
wherein the first portions of the first and second support elements are located at a first end of the unitary structure and the second portions of the first and second support elements are located at a second end of the unitary structure and comprise cantilever structures.

4. A sensor according to claim 2,
wherein the first portions of the first and second support elements are located at a first end of the unitary structure, wherein each of the first and second support elements comprises a further first portion located at a second end of the unitary structure, and wherein the second portions of the first and second support elements are located between the first and second ends of the unitary structure.

5. A sensor according to claim 1,
wherein the first support element and the second support element are bonded directly to each other.

6. A sensor according to claim 2,
wherein the first support element and the second support element are bonded to each other by a spacer located between the first support element and the second support element.

7. A sensor according to claim 6, wherein said spacer comprises an elastically-deformable material.

8. A sensor according to claim 7,
wherein the spacer comprises an actuator that is configured to adjust the relative positions of the first optical reflector and the second optical reflector along the optical axis to change the cavity length of the optical cavity.

9. A sensor according to claim 8,
wherein the spacer is formed of a material which deforms when stimulated, thereby moving one or both of the optical reflectors relative to each other along the optical axis of the optical cavity.

10. A sensor according to claim 1,
further comprising an actuator configured to adjust the relative positions of the first optical reflector and the second optical reflector along the optical axis to change the cavity length of the optical cavity.

11. A sensor according to claim 1,
wherein the unitary structure is rigid such that the first optical reflector and the second optical reflector have a fixed separation.

12. A sensor according to claim 1,
comprising a plurality of said recesses providing a corresponding plurality of said optical cavities.

13. A sensor according to claim 12, wherein said plurality of optical cavities have different optical cavity lengths and/or optical mode volumes and/or optical mode shape thereby providing more than one cavity length and/or optical mode volume and/or mode shape.

14. A sensor according to claim 12,
wherein the at least one EM radiation source is configured to illuminate the plurality of optical cavities.

15. A sensor according to claim 1,
wherein the at least one EM radiation source is configured to illuminate the optical cavity or the plurality of optical cavities with EM radiation comprising a plurality of frequencies.

16. A sensor according to claim 1,
comprising a plurality of said recesses providing a corresponding plurality of said optical cavities, wherein said plurality of optical cavities have different optical cavity lengths,
wherein the at least one EM radiation source is configured to illuminate the plurality of optical cavities with EM radiation comprising a plurality of frequencies.

17. A sensor according to claim 12,
wherein the detector is arranged to detect EM radiation from the plurality of optical cavities and to discriminate between EM radiation from the different optical cavities.

18. A sensor according to claim 1, wherein said EM radiation source and/or said detector is arranged directly adjacent to said respective first or second optical reflector.

19. A sensor according to claim 1,
further comprising at least one inlet for introducing a fluid sample into the sample space and at least one outlet for removing the fluid sample from the sample space.

20. A sensor according to claim 1,
further comprising a gasket structure between the first and second support elements, to contain a fluid sample within the sample space.
